(19) United States
(12) Patent Application Publication
(10) Pub. No.: US 2025/0262808 A1
(43) Pub. Date: Aug. 21, 2025

(54) INJECTION MOLD COMPONENT

(71) Applicant: Husky Injection Molding Systems Ltd., Bolton (CA)

(72) Inventor: Ralf Walter Fisch, Saarburg (DE)

(73) Assignee: Husky Injection Molding Systems Ltd., Bolton (CA)

(21) Appl. No.: 18/730,605

(22) PCT Filed: Jan. 25, 2023
(86) PCT No.: PCT/CA2023/050089

§ 371 Date: Jul. 19, 2024

Related U.S. Application Data
(60) Provisional application No. 63/268,071, filed on Feb. 16, 2022.

(51) Int. Cl. B29C 45/28; B29C 45/27

(52) U.S. Cl. CPC B29C 45/2803; B29C 45/2708

(57) ABSTRACT

A mold assembly (101) for a valve-gated injection mold (191) configured to mitigate tearing along the vestige of a molded part. The assembly (101) includes a gate insert (131) with a nozzle seat (111) which receives a valve-gate injection nozzle assembly (110), a mold cavity portion (132) describing part of a mold cavity, a connecting passageway (124) between the nozzle seat (111) and the mold cavity portion (132) and a vestige forming portion (135) between the connecting passageway (124) and the mold cavity portion (132). An end portion (133) of a valve member (118) of the valve-gate injection nozzle assembly (110) cooperates with a scaling portion (125) of the connecting passageway (124) when the valve member (118) is in a closed position. The vestige forming portion (135) is wider than the sealing portion (125), providing a step (171) having a radial dimension (R2) that is greater than an axial length (L2) of the vestige forming portion (135).

### FIELD OF THE INVENTION

This invention relates generally to injection mold components. More specifically, although not exclusively, this invention relates to an injection mold component for a valve-gated injection mold and associated mold stacks, mold assemblies, molds, molding systems for molding preforms and other articles, for example tubular articles, and to associated methods and molded articles.

### BACKGROUND OF THE INVENTION

Molding is a process by virtue of which a molded article can be formed from molding material, such as a plastics material, by using a molding system, such as an injection molding system or a compression molding system. Various molded articles can be formed by using such molding processes including, for example, preforms which can be formed from polyethylene terephthalate (PET) material. Such preforms are capable of being subsequently blown into a container, for example a beverage container, bottle, can or the like.

Injection molding nozzles are well known and are used to inject materials, such as plastic, into cavities of a mold. For example, such nozzles receive molten material, such as plastic, from an injection molding machine and direct the material into mold cavities through passages called gates. When an injection operation is complete, and prior to opening the mold cavity to eject the molded parts, the transfer of molten material through the gates must be stopped. Generally, two methods exist for stopping the transfer of molten material through the gates, namely: thermal, or open, gating; and valve gating.

In thermal gating, the gate is an open aperture through which molten material passes during an injection operation. The gate is rapidly cooled at the end of the injection portion of the cycle, when the injection pressure is removed, to “freeze” the injected material into a plug. This plug remains in the gate to prevent drool of molten material from the gate when the mold is open for the ejection of the molded part. In the next injection portion of the cycle, the cooling applied to the gate is effectively removed and hot molten material from the injection molding machine pushes the remaining plug into the mold cavity, where it melts and mixes with the newly provided molten material.

In valve gating, the opening and closing of the gate is independent of injection pressure and/or cooling and is achieved mechanically with a valve stem. This stem can be moved between an open position, wherein flow of molten materials through the gate is permitted, and a closed position wherein the gate is closed by entry of the valve stem into the gate which establishes a seal, preventing molten materials from passing through the gate. Valve gating is well known and examples of such systems are shown in U.S. Pat. Nos. 2,878,515; 3,023,458; and 3,530,539, each being incorporated herein by reference.

Generally, for situations that require improved aesthetics, valve gating is preferable to thermal gating because it can reduce the undesired gate vestige which results on the finished molded part. Preforms are one example of such finished molded parts. Injection molding of preforms involves heating PET material (or other suitable molding material for that matter) to a homogeneous molten state and injecting, under pressure, the so-melted material into a molding cavity defined, at least in part, by a female cavity piece and a male core piece. Typically, the female cavity piece is mounted to a cavity plate and the male core piece is mounted to a core plate of a mold. The cavity plate and the core plate are urged together and are held together by clamp force, the clamp force being sufficient to keep the cavity and the core pieces together against the pressure of the injected material. The molding cavity has a shape that substantially corresponds to a final cold-state shape of the molded article to be molded. The so-injected material is then cooled to a temperature sufficient to enable removal of the so-formed molded article from the molding cavity. When cooled, the molded article shrinks inside of the molding cavity and, as such, when the cavity and core plates are urged apart, the molded article tends to remain associated with the core piece.

A typical molding insert stack assembly that can be arranged (in use) within a molding machine, for making preforms, includes a gate insert which incorporates the gate and a molding surface that describes a closed end of the preform. The molding insert stack assembly also includes a split mold insert pair that, together with a mold cavity insert, the gate insert and a core insert, defines a molding cavity. Molding material can be injected into the molding cavity from a source of molding material via the gate in the gate insert to form a molded article. In order to facilitate forming of the neck region of the molded article and subsequent removal of the molded article therefrom, the split mold insert pair comprises a pair of complementary split mold inserts that are mounted on adjacent slides of a slide pair. The slide pair is slidably mounted on a top surface of a stripper plate.

One known issue with valve gating systems in preform molds is that the valve stem and gate each have mating sealing portions with a small diametrical clearance between the valve stem and the gate sealing portions. As the valve stem is moved into alignment with the sealing portion of the gate to effect sealing, a slight misalignment of the stem with the gate will cause the stem to strike the gate sealing portion. Over time, this will cause the gate area to wear and become misshapen. Once the gate sealing area is worn, the stem no longer stops the flow of molten material and a small amount of molten material will migrate between the stem and the worn gate sealing area. This leakage adversely impacts the vestige quality because as the mold is opened, the now-solidified material between the gate and the valve stem will cause a tear or blemish to form along a side of the vestige of the part, and in extreme cases, the tearing can propagate to the surface of the molded article or preform (this phenomenon is commonly known as ‘gate tearing’).

Following the injection cycle, typically the mold halves will open and the molded article in a somewhat solidified state will be removed from the stem/gate area. Due to the entrapped molten material between the worn gate area and the stem, the molded article will not break away cleanly when the mold is opened, but rather will tear away from the gate area, which results in a blemished vestige on the molded article.

To mitigate this issue, U.S. Pat. No. 7,156,651 proposes a vestige forming portion having a larger diameter than the gate sealing portion of the gate insert. This provides a radial step between the gate sealing portion and the vestige forming portion, which mitigates tearing along the vestige of the part. Whilst the configuration proposed in this document has been found to enable tearing along the vestige of the part to be eliminated, it would be advantageous to improve the operating window within which this can be achieved.

### SUMMARY OF THE INVENTION

The present invention seeks to mitigate tearing along the vestige of the part across a broader window of operating parameters, specifically but not exclusively in the manufacture of tubular articles such as preforms. This invention is directed, in particular but not exclusively, to an injection mold component for a valve-gated injection mold and associated mold stacks, mold assemblies, molds, molding systems for molding preforms and other articles, for example tubular articles, and to associated methods and molded articles. In the case of tubular articles such as preforms, the articles may have a base portion at a closed end, a neck finish at an open end and a body portion therebetween. The neck finish may include one or more radial flanges, which may extend outwardly. The neck finish may include engaging features, such as threads or a snap fit finish. The preform and/or neck finish may comprise any one or more other features described above in relation to known preform designs. In addition, any of the foregoing features described in relation to known mold stacks and components thereof, molds and molding systems may be incorporated within an injection mold component and associated mold stacks, mold assemblies, molds, molding systems for molding preforms and other articles, for example tubular articles, and to associated methods and molded articles according to the invention, insofar as they are consistent with the disclosure herein.

According to a first broad aspect of the present invention, there is provided a component, e.g. for a valve-gated injection mold, which comprises a nozzle seat, a mold cavity portion, a connecting passageway with a sealing portion and a vestige forming portion which is wider than the sealing portion, thereby to provide a step having a radial dimension that is greater than an axial length of the vestige forming portion.

The applicant has determined that the provision of a step having a radial dimension that is greater than an axial length of the vestige forming portion improves the operating window within which tearing along the vestige of the part can be mitigated. This has been found, surprisingly, to outweigh the potentially negative impact on cooling efficiency in the vestige region, which the skilled person might normally expect.

The component may comprise an injection mold component. The nozzle seat may be for receiving a valve-gate injection nozzle assembly. The mold cavity portion may describe part of a mold cavity, e.g. for molding an article.

The connecting passageway may be between the nozzle seat and the mold cavity portion. The vestige forming portion may be between the connecting passageway and the mold cavity portion. The sealing portion may extend from the vestige forming portion and/or along at least part of the connecting passageway.

The sealing portion may be configured to cooperate, in use, with an end portion of a valve member of a valve-gate injection nozzle assembly received, in use, by the nozzle seat when the valve member is in a closed position.

At least one or more or each of the component, nozzle seat, molding surface, connecting passageway, vestige forming portion and sealing portion may comprise an axis. At least one or more or each of the component, nozzle seat, molding surface, connecting passageway, vestige forming portion and sealing portion may extend about the axis. At least one or more or each of the component, nozzle seat, molding surface, connecting passageway, vestige forming portion and sealing portion may comprise a cross-section, e.g. perpendicular to the axis, which is circular or non-circular, such as elliptical, square or rectangular. At least one or more or each of the component, nozzle seat, molding surface, connecting passageway, vestige forming portion and sealing portion may be substantially symmetrical about the axis. The step may comprise or provide an annular step. The step may extend about the axis of the component, e.g. to provide an annular step.

The connecting passageway and/or sealing portion may comprise a first diameter. The width of the connecting passageway may correspond to the first diameter. The vestige forming portion may comprise a second diameter. The width of the vestige forming portion may correspond to the second diameter. The second diameter may be larger than the first diameter. The step may have a radial component, e.g. corresponding to or providing the radial dimension. The step may have an axial component, which may correspond to the axial dimension of the vestige forming portion.

The molding surface may comprise an article or preform molding surface. The molding surface may be curved. The vestige forming portion may include a top and/or radial annular surface, e.g. a top and/or radial annular vestige molding surface. The top and/or radial annular surface may describe the radial dimension. The vestige forming portion may include a side and/or circumferential and/or cylindrical surface, e.g. a side and/or circumferential and/or cylindrical vestige molding surface. The side and/or circumferential and/or cylindrical surface may describe the axial length.

The radial dimension of the step may be at least 5% greater than the axial length of the vestige forming portion. Preferably, the radial dimension of the step is at least 10% greater than the axial length of the vestige forming portion. More preferably, the radial dimension of the step is at least 15% greater than the axial length of the vestige forming portion and/or at most 25% greater than the axial length of the vestige forming portion, for example about 20% greater than the axial length of the vestige forming portion.

The width or diameter of the vestige forming portion may be at least 20% greater than the width or diameter of the sealing portion. Additionally or alternatively, the width or diameter of the vestige forming portion may be at least 5 times the axial length of the vestige forming portion.

The vestige forming portion may have an axially extending surface, which may be joined to the mold cavity portion by a non-tangential transition or by a corner.

According to another broad aspect of the present invention, there is provided a component, e.g. for a valve-gated injection mold, which comprises a nozzle seat, a mold cavity portion, a connecting passageway with a sealing portion and a vestige forming portion having an axially extending surface joined to the mold cavity portion by a non-tangential transition or by a corner.

The applicant has also found that the provision of a non-tangential transition or corner joining the axially extending surface of the vestige forming portion to the mold cavity portion improves the operating window within which tearing along the vestige of the part can be mitigated, without causing the demolding issues, which the skilled person might normally expect.

The non-tangential transition or corner may be substantially sharp. The non-tangential transition or corner may have a radius of 0.05 mm or less. Preferably, the non-tangential transition or corner has a radius of 0.03 mm or less. More preferably, the non-tangential transition or corner has a radius of 0.02 mm or less, e.g. 0.01 mm or less. The corner may have a radius of 0.05 mm or less. Preferably, the corner has a radius of 0.03 mm or less. More preferably, the corner has a radius of 0.02 mm or less, e.g. 0.01 mm or less.

The vestige forming portion may be substantially cylindrical. Additionally or alternatively, the vestige forming portion may comprise an annular surface. The annular surface may extend radially from the sealing portion, e.g. to describe at least part of the step. Additionally or alternatively, the vestige forming portion may comprise a cylindrical surface. The cylindrical surface may extend axially from the annular surface. Thus, the cylindrical surface may comprise or provide the aforementioned axially extending surface.

The radial dimension of the step may correspond to a radial distance from the sealing portion to the substantially cylindrical surface. Additionally or alternatively, the axial length of the vestige forming portion may be described from the annular surface to an end of the cylindrical surface.

The cylindrical surface may be joined at its end to the mold cavity portion by the or a non-tangential transition or by the or a corner. The mold cavity portion may comprise a convex transition forming portion. In examples with a convex transition portion, it may be joined to the end of the cylindrical surface of the vestige forming portion by a non-tangential transition or by a corner, e.g. the aforementioned non-tangential transition or corner.

The annular surface may be joined to the circumferential surface by a corner, which may be substantially sharp. The corner may have a radius of 0.05 mm or less. Preferably, the corner has a radius of 0.03 mm or less.

The annular surface may be joined to the sealing portion by a corner, which may be substantially sharp. The corner may have a radius of 0.05 mm or less. Preferably, the corner has a radius of 0.03 mm or less. More preferably, the corner has a radius of 0.02 mm or less, e.g. 0.01 mm or less.

The component may comprise a cooling channel, e.g. for receiving a cooling fluid to cool the vestige forming portion and/or the mold cavity portion. The mold cavity portion may comprise or describe a base forming portion for forming an outer surface of a base portion of the molded article. The base forming portion may be concave and/or may extend from the convex transition forming portion of the mold cavity portion. The base forming portion may be spherical or substantially spherical. The base forming portion may be conical or substantially conical. The convex transition forming portion may be toroidal or substantially toroidal.

The nozzle seat may comprise a receptacle, e.g. for receiving an end of a valve-gate injection nozzle assembly and/or an insulator thereof. The receptacle may comprise a tapered or conical surface, which may extend from the connecting passageway. The receptacle may comprise a cylindrical surface, which may extend from the tapered or conical surface.

The component may comprise a mold insert. The component may comprise part of a mold stack, which may be for incorporation or inclusion within an injection mold or a preform mold, e.g. a preform injection mold. The component or insert may comprise a cavity insert or a gate insert.

Another aspect of the invention provides a mold stack comprising a plurality of mold inserts which together define a mold cavity, wherein one of the mold inserts comprises a component as described above. The mold stack may comprise one or more or each of a cavity insert, a core insert, a split mold insert. The assembly or mold stack may comprise a lock ring. The mold cavity may be configured to make or mold or form a preform.

Another aspect of the invention provides an assembly, e.g. for a valve-gated injection mold, the assembly comprising one or more mold components and/or mold stacks as described above. The assembly may comprise a mold assembly, e.g. an injection mold assembly.

The assembly may comprise one or more mold plates, for example to which or within which the component or mold stack may be mounted. The assembly may comprise a first plate, e.g. to which the or each component may be mounted. The first plate may comprise a cavity plate, e.g. to which the or each cavity and/or gate insert may be mounted. The assembly may comprise a core plate, e.g. to which the or each core may be mounted. The assembly may comprise a stripper plate, e.g. to which the or each split insert may be mounted. The or each split insert may comprise first and second parts each of which may be mounted to a respective slide. Each slide may have a plurality of split insert parts mounted thereto, for example one split insert part of each of a plurality of split inserts. The slides may be mounted to the stripper plate, e.g. movably mounted thereto. The assembly may comprise one or more wear plates between the slides and the stripper plate, e.g. along which the slides may be movable to separate the parts of the or each split insert for ejecting molded articles.

The assembly may comprise a nozzle assembly, e.g. a valve-gate injection nozzle assembly. The nozzle assembly may be received by the nozzle seat of the component. The nozzle assembly may comprise a valve member. The valve member may be movable between open and closed positions.

Molten material may be allowed to flow, in use, through the connecting passageway to the mold cavity portion in the open position. The valve member may extend through the connecting passageway in the closed position. The valve member may cooperate with the sealing portion, e.g. to inhibit the flow of molten material through the connecting passageway, in the closed position.

Optionally, a tip of the valve member may project into the vestige forming portion in the closed position, for example such that the valve member cooperates with the entire length of the sealing portion to inhibit the flow of molten material through the connecting passageway.

As mentioned above, the step of the vestige forming portion may be joined to the sealing portion by a substantially sharp corner. Additionally or alternatively, a chamfered tip of the valve member may be located entirely within the vestige forming portion in the closed position. By making the corner between the step and the sealing portion sharp and locating the chamfered tip of the valve member entirely within the vestige forming portion, this ensures that the sealing portion of the connecting passageway is substantially free of any molten material when the valve member is moved to the closed position.

The valve member may project into the vestige forming portion along only part of the axial length of the vestige forming portion. In some cases, the valve member extends along at least half of the axial length of the vestige forming portion. The valve member may comprise a valve stem.

The assembly may comprise a plurality of nozzle assemblies, e.g. each received by the nozzle seat of a respective one of the components. The assembly may comprise a melt distributor, e.g. within which the or each nozzle assembly is received.

Another aspect of the invention provides a preform mold comprising a component or a mold stack or a mold assembly as described above.

Another broad aspect of the invention provides a molding system, e.g. for molding tubular articles. The system may comprise a mold assembly as described above. The system may comprise a machine, e.g. an injection molding machine, to or within which the mold assembly may be mounted. The machine may be configured or operable to mold tubular articles, e.g. preforms, using the mold assembly.

Another aspect of the invention provides a computer program element comprising and/or describing and/or defining a three-dimensional design, e.g. of the component described above or an embodiment thereof. The three-dimensional design may be for use with a simulation means or an additive or subtractive manufacturing means, system or device.

The computer program element may be for causing, or operable or configured to cause, an additive or subtractive manufacturing means, system or device to manufacture the component described above or an embodiment thereof. The computer program element may comprise computer readable program code means for causing an additive or subtractive manufacturing means, system or device to execute a procedure to manufacture the component described above or an embodiment thereof.

A yet further aspect of the invention provides the computer program element embodied on a computer readable medium.

Another aspect of the invention provides a method of making a molded article. The method may, but need not, comprise the use of one of the aforementioned component, mold stacks, mold assemblies, molds or molding systems described above. The method may comprise any one or more features or steps relevant to or involving the use of any feature of any of the component, mold stacks, mold assemblies, molds or molding systems described above.

Another aspect of the invention provides a method of making a molded article. The method may, but need not, comprise the use of the components, mold stacks, mold assemblies, molds or molding systems described above.

The method may comprise injecting a molten material into a mold cavity, e.g. through a connecting passageway, to fill the mold cavity. Additionally or alternatively, the method may comprise moving a valve member of a valve-gate injection nozzle to a closed position, e.g. in which the valve member cooperates with a sealing portion of the connecting passageway to inhibit the flow of molten material through the connecting passageway. Additionally or alternatively, the method may comprise cooling the molten material until it solidifies to form a molded article.

The molded article may include a vestige, which may be formed by a vestige forming portion between the sealing portion of the connecting passageway and the mold cavity. The vestige forming portion may be wider or have a larger diameter than the sealing portion, e.g. such that a step is described which has a radial dimension that is greater than an axial length of the vestige forming portion.

The method may comprise moving the valve member to the closed position, e.g. such that it extends through the connecting passageway with a tip of the valve member projecting into the vestige forming portion. The valve member may project into the vestige forming portion such that the valve member cooperates with the entire length of the sealing portion, e.g. to inhibit the flow of molten material through the connecting passageway.

The step of the vestige forming portion may be joined to the sealing portion by a substantially sharp corner, e.g. such that the sealing portion of the connecting passageway is substantially free of any molten material when the valve member is moved to the closed position.

For the avoidance of doubt, any of the features described herein apply equally to any aspect of the invention. Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible.

For the avoidance of doubt, the terms “may”, “and/or”, “e.g.”, “for example” and any similar term as used herein should be interpreted as non-limiting such that any feature so-described need not be present. Indeed, any combination of optional features is expressly envisaged without departing from the scope of the invention, whether or not these are expressly claimed. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

Embodiments of the invention will now be described by way of example only with reference to the accompanying drawings in which:

FIG. 1 is a simplified cross-sectional view of an injection molding nozzle and gate insert in accordance with the prior art;

FIG. 2 is an enlarged view of the gate area of the gate insert of FIG. 1;

FIG. 3 is a simplified cross-sectional view of a mold assembly according to the invention; and

FIG. 4 is an enlarged view of the gate area of the gate insert of the mold assembly of FIG. 3.

### DETAILED DESCRIPTION OF THE INVENTION

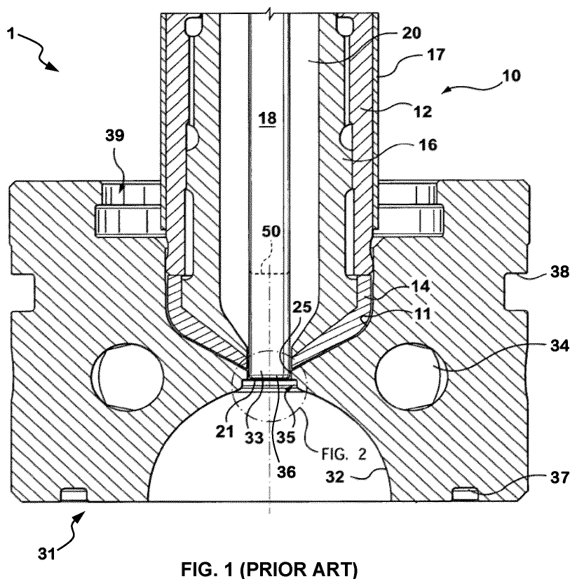

With reference to FIG. 1, there is depicted an example of a known mold assembly 1 for a valve-gated injection mold. The mold assembly 1 includes a valve-gate injection molding nozzle assembly 10 having an elongated nozzle body 12 with a nozzle tip 16 threadedly affixed co-axially therein. Typically, a heater 17 is installed on the outside of nozzle assembly 10 to maintain the molten material in a molten state. An insulator 14 is normally affixed to the end of the nozzle tip 16, thereby thermally insulating the heated nozzle assembly 10 from a cooled gate insert 31. A movable valve stem 18 extends co-axially in the nozzle assembly 10 and is selectably positioned in or out of a passageway in the nozzle. A melt channel 20 surrounds the valve stem 18 and runs the length of the nozzle assembly 10 to communicate a molten material to a mold cavity portion 32.

The valve stem 18 is a slender elongated cylindrical piece that is moved up and down to an open and closed position respectively. When the valve stem 18 is in the open position, as shown by phantom line 50, the molten material in melt channel 20 is allowed to enter the mold cavity portion 32. When placed in the closed position, an end portion 33 of valve stem 18 is received in a sealing portion 25 of the gate insert 31, thereby stopping the flow of material to the mold cavity portion 32.

A face portion 21 of valve stem 18 and a vestige forming portion 35 of the gate insert 31 define the entire top and side of the molded article vestige. A chamfer 36 is typically provided along the face of the valve stem 18 to help guide the valve stem into the sealing portion 25 of gate insert 31 and reduce wear of the valve stem and gate insert 31.

Due to the close fit of the valve stem 18 to the sealing portion 25, any misalignment that exists between their respective interfaces will cause the valve stem 18 to strike the surface of the sealing portion 25 which will ultimately lead to a deterioration of the sealing portion 25 and/or the valve stem 18. Gate insert 31 provides a component that can be replaced as the sealing portion 25 wears rather than replacing the entire cavity insert or plate if the sealing portion 25 and a recessed nozzle seat 11 for receiving nozzle assembly 10 were formed directly therein, as may still be done with smaller number of cavities. However, gate insert 31 still is a fairly detailed component and it is undesirable to replace it unless absolutely necessary.

As will be appreciated by those skilled in the art, the gate insert 31 is one of a plurality of mold inserts, which together describe a complete mold cavity. The mold inserts are received within a series of plates (not shown), which supply them with cooling fluid. In this regard, the gate insert 31 includes cooling channels 34, grooves 37 and 38 for receiving o-rings to sealingly cooperate with cooling channels in the mold plates (not shown) and a pocket 39 for ease of removal and installation of the gate insert 31 into a cavity or cavity plate (not shown).

At the end of the injection cycle, the valve stem 18 is moved into its closed position, as previously described, and the molding inserts are held in a closed position for a predetermined cycle time to allow the molten material to cool and solidify, thereby forming the molded article. Once the molded article has been allowed to cool to a sufficient level, a core (not shown) with the molded article thereon is moved away from the gate insert 31 and the vestige of the molded article is pulled away from the face portion 21 of the valve stem 18. If enough wear exists between the valve stem 18 and the sealing portion 25, a small amount of molten material will have migrated therein, and consequently as the vestige is moved away from the vestige forming portion 35 an edge may also be peeled away from the vestige of the molded article.

Moreover, as the valve stem 18 is surrounded by molten material, it becomes quite hot. When the gate is closed by the valve stem 18, the hot tip of the valve stem 18 cools slower than the gate insert 31 and the mold cavity portion 32 are cooled. Ideally, the molded article is not removed from the mold until the vestige has cooled sufficiently to allow a clean separation of the solidified material at the face portion 21 of the valve stem 18. With the valve stem 18 being hot compared to the gate insert 31, this can require increased cycle times to permit the necessary cooling and/or can result in undesirable characteristics in the molded article. Specifically, as the material in the mold cavity portion 32 adjacent the valve stem 18 is cooled relatively slowly due to the hot valve stem 18, parts molded from thermally sensitive materials, such as PET, can suffer from an enlarged area of crystallinity or other undesired characteristics. To reduce cycle times, a mold may be opened before the material adjacent the face portion 21 has solidified sufficiently. As the entire top surface of the vestige is in contact with the face portion 21 of the hot valve stem 18, stringing and/or an uneven edge may form when the mold is opened.

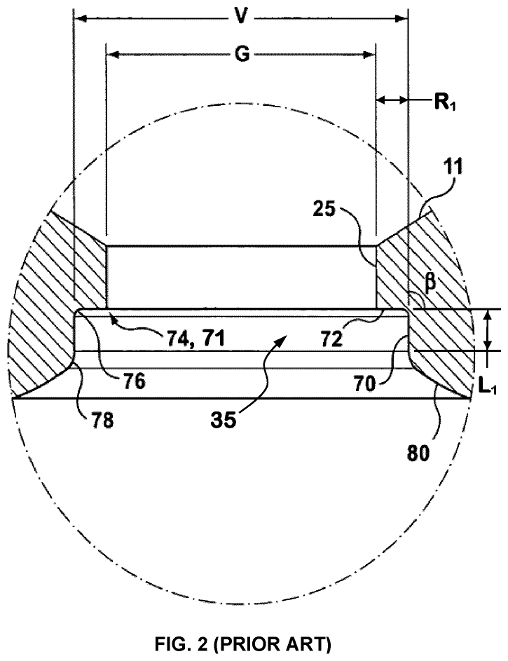

Referring now to FIG. 2, a gate area of the gate insert 31 is shown. The sealing portion 25 and the vestige forming portion 35 are formed by first and second cylindrical bores that are both concentrically configured through a central portion of the gate insert 31. The first cylindrical bore is configured adjacent the nozzle seat 11, and an inlet end thereof is configured for fluid communication with the nozzle assembly 10. An inner circumferential surface of the first bore provides the gate sealing portion 25 and accordingly has first diameter, G. The second cylindrical bore is configured directly beneath the first cylindrical bore, with a discharge end of the first cylindrical bore in fluid communication therewith. The second cylindrical portion has been configured to provide side and top portions 70, 72 of the vestige forming portion 35. Accordingly, the second cylindrical bore has a second diameter, V, that is wider than that of the first cylindrical bore.

As a result, the vestige forming portion 35 extends radially outwardly from the sealing portion 25 such that the first diameter G of the sealing portion 25 is smaller than the second diameter V of the vestige forming portion 35, thereby providing a radial step 71. The step 71 has a radial dimension or width, R₁, corresponding to the radial distance between the sealing portion 25 to the cylindrical surface 70. Accordingly, a vestige is formed on the molded article in the vestige forming portion 35 that includes an outer circumferential portion corresponding to an annular portion 72 of the vestige forming portion 35. The annular portion 72 is configured between the gate sealing portion 25 and a side portion 70 of the vestige forming portion 35. The vestige forming portion 35 therefore includes a top portion, which includes the annular portion 72 and the face portion 21 of the valve stem 18 when the valve stem is in the closed position. The annular portion 72 is a residual portion of the top of the second cylindrical bore, which is adjacent the discharge end of the first cylindrical bore. The side portion 70 is the inner circumferential surface of the second cylindrical bore, and describes an axial length L₁ of the vestige forming portion 35, which is considerably more than the radial dimension or width R₁.

It is the interaction of the outer circumferential portion of the vestige of the molded article and the annular portion 72 of the vestige forming portion 35 which inhibits gate tearing. In addition, the side portion 70 is substantially perpendicular to the annular portion 72, as gate tear is typically reduced as β approaches 90°.

The corner 74 between the annular portion 72 and the gate sealing portion 25 is configured to be sharp. The vestige forming portion 35 also includes a blend radius 76 in the corner between the side and top portions of the vestige portion 35. The mold cavity portion 32 includes a transition portion made up of first and second outwardly diverging radial portions 78 and 80, which are configured to gradually blend the vestige forming portion 35 into the adjacent mold cavity. As shown clearly in FIG. 2, radial portion 78 projects tangentially from a lower edge of the side portion 70, thereby providing a smooth transition from the cylindrical side portion 70 into the convex or toroidal radial portion 78.

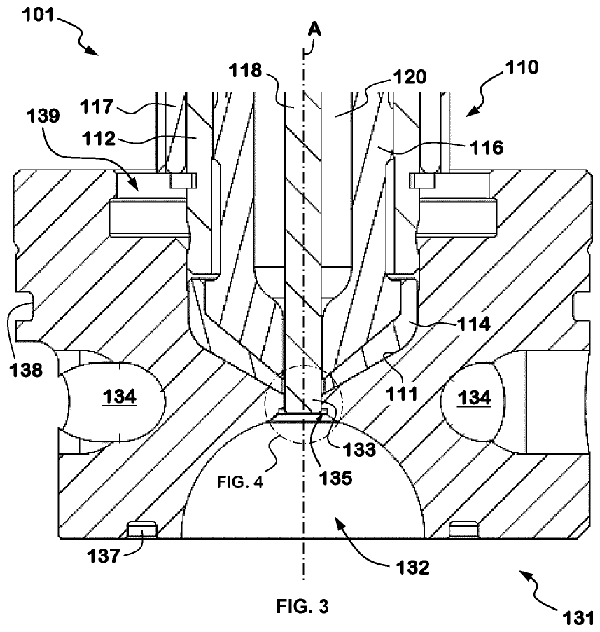

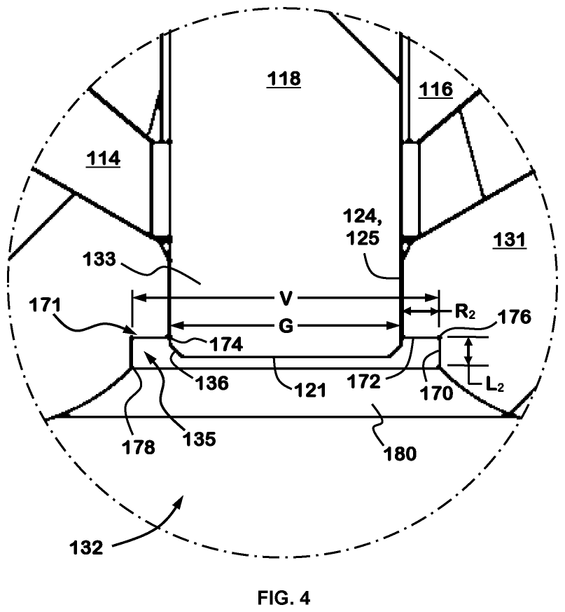

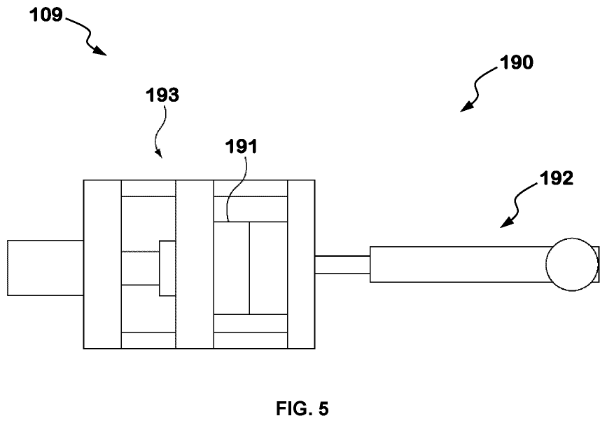

Turning now to FIGS. 3 and 4, there is shown a mold assembly 101 according to the invention, for use in a valve-gated injection mold. The mold assembly 101 according to the invention differs from the mold assembly 1 described above primarily in relation to the gate area illustrated in FIG. 4. More particularly, and as will be described in more detail below, the geometry of a vestige forming portion 135 of a gate insert 131 of the mold assembly 101 has been improved, as has the transition between the vestige forming portion 135 to a molding cavity portion 132 described by the gate insert 131. A specific positioning of a valve stem 118 in the closed position with respect to the improved geometry of the vestige forming portion 135 further contributes to the aforementioned improvements.

As shown in FIG. 3, the mold assembly 101 includes a valve-gate injection nozzle assembly 110 and an injection mold component 131, in the form of a gate insert 131 in this example. The nozzle assembly 110 includes an elongated nozzle body 112 with a nozzle tip 116 threadedly affixed co-axially therein. Optionally, a heater 117 may be installed on the outside of nozzle assembly 110 to maintain the molten material in a molten state. An insulator 114 may also be affixed to the end of the nozzle tip 116, thereby thermally insulating the heated nozzle assembly 110 from the gate insert 131. A movable valve member or valve stem 118 extends co-axially in the nozzle assembly 110 and is selectably positioned in or out of a passageway in the nozzle. A melt channel 120 surrounds the valve stem 118 and runs the length of the nozzle assembly 110 to communicate a molten material to a mold cavity portion 132.

The valve stem 118 is moved up and down to an open and closed position respectively. When the valve stem 118 is retracted in an open position, the molten material in melt channel 120 is allowed to enter the mold cavity portion 132. When deployed in the closed position, an end portion 133 of valve stem 118 is received in a sealing portion 125 of the gate insert 131, thereby stopping the flow of material to the mold cavity portion 132. The valve stem 118 includes a face portion 121 at the terminal end of the end portion 133, which is delineated by a chamfered tip 136. The gate insert 131 also includes cooling channels 134, grooves 137 and 138 for receiving o-rings to sealingly cooperate with cooling channels in the mold plates (not shown) and a pocket 139 for ease of removal and installation of the gate insert 131 into a cavity or cavity plate (not shown).

The gate insert 131 has an axis A and includes a recessed nozzle seat 111 for receiving the nozzle assembly 110. In this example, the nozzle seat 111 receives the insulator 114, but it may instead receive the nozzle tip 116 directly, as suggested above. The gate insert 131 also includes a mold cavity portion 132 describing part of a mold cavity for molding an article and a connecting passageway 124 between the nozzle seat 111 and the mold cavity portion 132. The vestige forming portion 135 is between the connecting passageway 124 and the mold cavity portion 132. The mold cavity portion 132 includes an outwardly diverging transition portion 180, which is convex or toroidal and blends gradually into an adjacent concave region of the mold cavity portion 132.

As illustrated more clearly in FIG. 4, the sealing portion 125 corresponds to at least the portion of the connecting passageway 124 that extends from the vestige forming portion 135 and cooperates with the end portion 133 of a valve member 118 of the nozzle assembly 110 when the valve member 118 is in a closed position. In this example, the sealing portion 125 extends along the entire connecting passageway 124, but it is envisaged that the connecting passageway 124 could be tapered or stepped, in which case the sealing portion 125 may only be provided by part of the connecting passageway 124.

The vestige forming portion 135 is substantially cylindrical, with a cylindrical surface 170 along its axial length L₂. The vestige forming portion 135 has a width or diameter V, which is greater than a width or diameter G of the sealing portion 125. An annular surface 172 extends radially from the sealing portion 125 to describe a step 171. A corner 174 joins the annular surface 172 to the sealing portion 125. The corner 174 is sharp, with a radius that is preferably 0.05 mm or less, more preferably 0.01 mm or less.

The cylindrical surface 170 extends axially from the annular surface 172 and is joined to it by another corner 176, which is also relatively sharp (e.g. 0.05 mm or less, preferably 0.03 mm or less). The transition portion 180 of the mold cavity portion 132 extends from the cylindrical surface 170, but unlike the known gate insert 31 shown in FIGS. 1 and 2, it is joined thereto by a non-tangential transition, such as yet another corner 178. The corner 178 is sharp, with a radius that is preferably 0.05 mm or less, more preferably 0.01 mm or less.

The step 171 has a radial dimension or width, R₂, corresponding to the radial distance between the sealing portion 125 to the cylindrical surface 170. The vestige forming portion 135 has an axial length L₂ corresponding to the axial distance from the annular surface 172 to an end of the cylindrical surface 170, which in this case is the corner 178. The radial dimension R₂ of the step 171 is greater than the axial length L₂ of the vestige forming portion 135.

At the end of the injection cycle, the valve stem 118 is moved into its closed position, in which the end portion 133 extends through the connecting passageway 124 with the chamfered tip 136 projecting into the vestige forming portion 135. As a result, the end portion 133 of the valve stem 118 cooperates with the entire length of the sealing portion 125 to inhibit the flow of molten material through the connecting passageway 124. As such, the face portion 121 of the valve stem 118, which describes an end of the vestige of the molded article, describes a slight depression within the vestige forming portion 135 and therefore within the vestige of the molded article. However, the applicant has determined that the valve stem 118 should not project into the vestige forming portion 135 along the entire axial length L₂ of the vestige forming portion 135, as this would result in a vestige being formed on the molded article that is entirely hollow, which is undesirable for reasons that would be appreciated by the skilled person.

The molding inserts are then held in a closed position for a predetermined cycle time to allow the molten material to cool and solidify, thereby forming the molded article. Once the molded article has been allowed to cool to a sufficient level, a core (not shown) with the molded article thereon is moved away from the gate insert 131 and the vestige of the molded article is pulled away from the face portion 121 of the valve stem 118. The provision of a step 171 having a radial dimension R₂ that is greater than the axial length L₂ of the vestige forming portion 135 has been determined to mitigate further the tendency for gate tearing, as has the sharp corner 178 joining the transition portion 180 of the mold cavity portion 132 to the cylindrical surface 170.

A marked improvement has been observed with a radial dimension R₂ that is at least 5% greater than the axial length L₂ of the vestige forming portion 135, but this improvement appears to be particularly advantageous with a radial dimension R₂ that is between 15% and 25% greater than the axial length L₂ of the vestige forming portion 135. In one advantageous example, the radial dimension R₂ was approximately 20% greater than the axial length L₂ of the vestige forming portion 135. The width or diameter V of the vestige forming portion 135 should be substantially more, for example at least 20% greater, than the width of the sealing portion 125 and at least 5 times the axial length L₂ of the vestige forming portion 135.

Turning now to FIG. 5, there is shown an injection molding system 109 including a machine 190 and a mold 191 incorporating a plurality of mold assemblies 101 described above. The machine 190 includes an injection unit 192 and a clamp unit 193 within which the mold 191 is mounted for operation as described above.

It will be appreciated that the configuration of the elements of the mold assembly 101 may vary, particularly although not exclusively as described above. It will also be appreciated by those skilled in the art that several variations to the construction and/or use of aforementioned examples are envisaged without departing from the scope of the invention. It will also be appreciated by those skilled in the art that any number of combinations of the aforementioned features and/or those shown in the appended drawings provide clear advantages over the prior art and are therefore within the scope of the invention described herein.

1-25. (canceled)

26. An injection mold component for a valve-gated injection mold, the component comprising:
a nozzle seat for receiving a valve-gate injection nozzle assembly;
a mold cavity portion describing part of a mold cavity for molding an article;
a connecting passageway between the nozzle seat and the mold cavity portion;
a vestige forming portion between the connecting passageway and the mold cavity portion; and
a sealing portion extending from the vestige forming portion along at least part of the connecting passageway, the sealing portion being configured to cooperate, in use, with an end portion of a valve member of the valve-gate injection nozzle assembly when the valve member is in a closed position;
wherein the vestige forming portion is wider than the sealing portion, thereby to provide a step having a radial dimension that is greater than an axial length of the vestige forming portion.

27. An injection mold component according to claim 26, wherein the radial dimension of the step is at least 5% greater than the axial length of the vestige forming portion.

28. An injection mold component according to claim 26, wherein the radial dimension of the step is at least 10% greater than the axial length of the vestige forming portion.

29. An injection mold component according to claim 26, wherein the radial dimension of the step is between 15% and 20% greater than the axial length of the vestige forming portion.

30. An injection mold component according to claim 26, wherein the width of the vestige forming portion is at least 20% greater than the width of the sealing portion.

31. An injection mold component according to claim 30, wherein the width of the vestige forming portion is at least 5 times the axial length of the vestige forming portion.

32. An injection mold component according to claim 26, wherein the vestige forming portion comprises an axially extending surface joined to the mold cavity portion by a substantially sharp corner.

33. An injection mold component according to claim 32, wherein the substantially sharp corner has a radius of 0.05 mm or less.

34. An injection mold component according to claim 26, wherein the vestige forming portion is substantially cylindrical with an annular surface extending radially from the sealing portion to describe at least part of the step and a cylindrical surface extending axially from the annular surface, the radial dimension of the step corresponding to a radial distance from the sealing portion to the substantially cylindrical surface and the axial length of the vestige forming portion being described from the annular surface to an end of the cylindrical surface.

35. An injection mold component according to claim 34, wherein the cylindrical surface is joined at its end to the mold cavity portion by a substantially sharp corner.

36. An injection mold component according to claim 35, wherein the mold cavity portion comprises a convex transition forming portion which is joined to the cylindrical surface of the vestige forming portion by the substantially sharp corner.

37. An injection mold component according to claim 35, wherein the substantially sharp corner has a radius of 0.05 mm or less.

38. An injection mold component according to claim 34, wherein the annular surface is joined to the circumferential surface by a substantially sharp corner.

39. An injection mold component according to claim 34, wherein the annular surface is joined to the sealing portion by a substantially sharp corner.

40. An injection mold component according to claim 26, wherein the component is a gate insert for a preform mold.

41. An injection mold component according to claim 26, comprising a cooling channel for receiving cooling fluid to cool the vestige forming portion and the mold cavity portion.

42. A mold assembly for a valve-gated injection mold, the assembly comprising:
an injection mold component according to claim 26; and
a valve-gate injection nozzle assembly received by the nozzle seat of the injection mold component, the valve-gate injection nozzle assembly comprising a valve member which is movable between:
an open position, in which molten material is allowed to flow, in use, through the connecting passageway to the mold cavity portion; and
a closed position, in which the valve member extends through the connecting passageway with a tip of the valve member projecting into the vestige forming portion such that the valve member cooperates with the entire length of the sealing portion to inhibit the flow of molten material through the connecting passageway.

43. A mold assembly according to claim 42, wherein the step of the vestige forming portion is joined to the sealing portion by a substantially sharp corner and a chamfered tip of the valve member is located entirely within the vestige forming portion in the closed position.

44. A mold assembly according to claim 43, wherein the valve member projects into the vestige forming portion along only part of the axial length of the vestige forming portion.

45. A mold assembly according to claim 44, wherein the valve member extends along at least half of the axial length of the vestige forming portion.

46. An injection mold comprising an injection mold component according to claim 26.

47. An injection mold comprising a mold assembly according to claim 42.

48. A method of making a molded article comprising injecting a molten material into a mold cavity through a connecting passageway to fill the mold cavity, moving a valve member of a valve-gate injection nozzle to a closed position in which the valve member cooperates with a sealing portion of the connecting passageway to inhibit the flow of molten material through the connecting passageway and cooling the molten material until it solidifies to form a molded article, wherein the molded article includes a vestige formed by a vestige forming portion between the sealing portion of the connecting passageway and the mold cavity, which is wider than the sealing portion such that a step is described which has a radial dimension that is greater than an axial length of the vestige forming portion.

49. A method of making a molded article according to claim 48, comprising moving the valve member to the closed position such that it extends through the connecting passageway with a tip of the valve member projecting into the vestige forming portion so that the valve member cooperates with the entire length of the sealing portion to inhibit the flow of molten material through the connecting passageway.

50. A method of making a molded article according to claim 49, wherein the step of the vestige forming portion is joined to the sealing portion by a substantially sharp corner such that the sealing portion of the connecting passageway is substantially free of any molten material when the valve member is moved to the closed position.

51. An injection mold component for a valve-gated injection mold, the component comprising:
a nozzle seat for receiving a valve-gate injection nozzle assembly;
a mold cavity portion describing part of a mold cavity for molding an article;
a connecting passageway between the nozzle seat and the mold cavity portion;
a vestige forming portion between the connecting passageway and the mold cavity portion; and
a sealing portion extending from the vestige forming portion along at least part of the connecting passageway, the sealing portion being configured to cooperate, in use, with an end portion of a valve member of the valve-gate injection nozzle assembly when the valve member is in a closed position;
wherein the vestige forming portion comprises an axially extending surface joined to the mold cavity portion by a substantially sharp corner.
